(19) United States
(12) Patent Application Publication
(10) Pub. No.: US 2004/0089750 A1
(43) Pub. Date: May 13, 2004

(54) Micro-array fluid dispensing apparatus and method

(76) Inventors: Muniswamappa Anjanappa, Ellicott City, MD (US); David T. Bach, Ellicott City, MD (US)

Correspondence Address: Clifford Kraft, 320 Robin Hill Dr., Naperville, IL, 60540, US

(21) Appl. No.: 10/689,480

(22) Filed: Oct. 20, 2003

Related U.S. Application Data
(60) Provisional application No. 60/420,800, filed on Oct. 23, 2002.

(51) Int. Cl. B05B 1/30

(52) U.S. Cl. 239/585.1

(57) ABSTRACT

A system and method for dispensing pico-liter amounts of fluid through a mechanical nozzle using a magnetostrictive device that changes dimensions under an applied magnetic field. This device, with the possible help of a bias magnet, can be used to open and close the end of a fluid dispensing nozzle. An X-Y positioner can position a slide beneath the nozzle to produce a micro-array of fluid spots. The magnetostrictive nozzle can dispense fluid quantities as low as 50 pico-liters and operate at a rate of up to 10 kHz.

This application is related to and claims priority from U.S. Provisional patent application No. 60/420,800 filed Oct. 23, 2002 and hereby incorporates that application by reference.

### BACKGROUND

1. Field of the Invention

The present invention relates generally to the field of biological instruments and more particularly to a magnetostrictive micro-array fluid dispensing system and method.

2. Description of the Prior Art

Micro-array fluid dispensing is the preferred method of fluid handling for disease prognosis and diagnosis, drug discovery, toxicology and numerous other procedures that are gaining acceptance in the biosciences. For example, DNA micro-array technology enables the cost-effective simultaneous analysis of thousands of sequences of DNA for genomic research and diagnosis applications.

A typical micro-array requires the spotting of nano-liter quantities of fluids creating “spots” of approximately 50-100 microns in diameter in a rectangular array on a chemically treated microscopic glass slide. The spots are usually placed approximately 200-250 microns apart. Currently, contact dispensing using solid pins, capillary tubes, tweezers, split pins and micro-spotting, or non-contact dispensing using solenoid and piezoelectric-based printing technologies is a common way to create these small spots. Contact methods are typically less accurate, slower and difficult to use to dispense pico-liter size drops. Non-contact dispensers primarily use either solenoid or piezoelectric actuation. A solenoid type nozzle uses a rod that can be moved up or down to seal and unseal the nozzle dispensing port with the help of a magnetic coil placed outside the nozzle. Here, the rod does not need any physical contact with the magnetic coil. Because the rods create positive contact with the outlet port, they are “self-sealing” and eliminate any leakage due to change in head pressure. The use of such a device is limited primarily because of its low speed (with a maximum of around 1.2 kHz). Non-contact piezoelectric nozzles have higher speed (up to 10 kHz) and better resolution than solenoid nozzles. Because the piezoelectric nozzles require application of high electric voltage, they require a physical wire connection to two opposite surfaces of the piezoelectric material. Their design typically requires costly multi-layer structures, and they typically lack the self-sealing property. This makes them vulnerable to changes in head pressure.

What is badly needed is a high speed nozzle that overcomes these limitations.

### SUMMARY OF THE INVENTION

The present invention relates to a micro-dispensing nozzle with a housing or fluid containing compartment with at least one exit orifice. A magnetostrictive valve is placed in proximity to the orifice with this magnetostrictive valve having an open state and a closed state. A means for applying a magnetic field such as a magnetic field coil is placed in proximity to the housing. Application of this magnetic field causes the magnetostrictive valve to change shape in response to the magnetic field. This change in shape causes the orifice to change states and either open or close the valve. A common embodiment of the present invention is where the magnetostrictive material is configured into the shape of a rod about 2 mm in diameter and about 30 mm long. Usually the magnetostrictive material operates such that magnetostrictive rod lengthens under application of a magnetic field. However, it is also possible to operate the rod in a manner where the rod contracts under the applied control magnetic field. In this mode, the rod is held in a pre-extended state by a bias magnetic field which can usually be conveniently supplied by a permanent magnet or by a bias coil. In this state, the pre-extended state of rod is relaxed upon application of the control magnetic field (which cancels the bias field), and the rod contracts causing the orifice to open. The control magnetic field is usually supplied by an external field coil. Normally the housing contains an entrance orifice that is coupled to a precision pump to maintain pressure on the fluid in the housing.

Alternative embodiments of the present invention use a magnetostrictive particle or a magnetostrictive layer to operate a valve or to squeeze fluid out of a nozzle outlet.

### DESCRIPTION OF THE DRAWINGS

FIG. 1 shows a magnetostrictive rod-based nozzle.

FIG. 2 is a plot of magnetostriction versus magnetic field.

FIG. 3 shows a magnetostrictive particle-based nozzle.

FIG. 4 shows magnetostrictive thin film-based nozzle.

FIG. 5 shows an integrated micro-array dispensing system.

Several illustrations have been presented to better illustrate the present invention. The invention is not limited to the embodiments shown in the drawings.

### DESCRIPTION OF THE INVENTION

The present invention relates to a magnetostrictive nozzle for micro-array fluid dispensing. It is known that magnetostrictive material is usually an alloy of Terbium, Dysprosium and Iron. Rods of typical magnetostrictive material are commercially available. These rods are usually cylindrical in cross-section and physically elongate in the presence of an applied magnetic field. These rods can be actuated accurately at speeds up to 10 kHz. Because magnetic excitation requires no physical contact with the actuator, the design of a magnetostrictive nozzle is very reliable. Furthermore, the presence of the magnetostrictive rod can optionally be used to create ultrasonic vibrations in the nozzle to provide an optional “self-cleaning” capability.

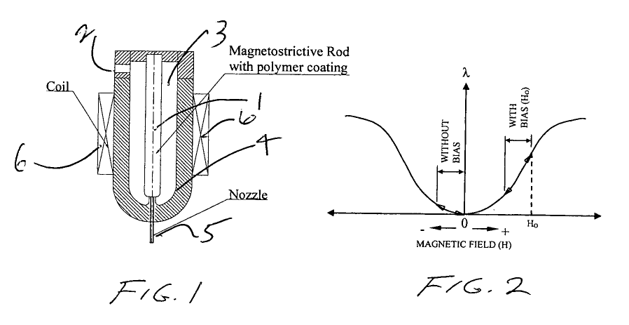

FIG. 1 shows a rod-based magnetostrictive nozzle. A polymer coated magnetostrictive rod 1 that can be around 2 mm in diameter and 30 mm long is fixed at one end to nozzle housing 4. Fluid enters the nozzle from a side opening 2 and flows down an annular space 3 between the rod 1 and the nozzle housing 4. A nozzle 5 extends downward form the nozzle housing 4. The nozzle 5 is kept normally closed by the magnetostrictive rod 1. A magnetic coil 6 surrounds the nozzle housing 4. It is desirable to keep the nozzle normally closed with the bottom end of the rod 1 blocking the top end of the nozzle 5. The nozzle can be opened by passing a current through the magnetic coil 6 that in turn causes a magnetic field to pass through the magnetostrictive rod 1.

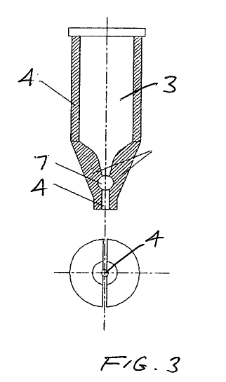

Normally a magnetostrictive rod increases in length under an applied magnetic field. However, in the present invention, it is desirable for the rod to contract so that the nozzle is open when current is applied. FIG. 2 shows a graph of magnetostriction vs. applied magnetic field. It can be seen that this function resembles an upside-down bell curve. A bias magnet (not shown in FIG. 1) can be used in the present invention to offset the function shown in FIG. 2.

When a fixed DC magnetic bias is applied (by using a small permanent magnet), the rod 1 is pre-extended exactly the right among to close the nozzle 5. When an external magnetic field is applied to the rod by passing DC current through the magnetic coil 6 in a direction to create a magnetic field that opposes the fixed bias field, the rod will contract and open the nozzle 5. Thus, by use of a bias magnet, the nozzle 5 opens when current is applied to coil 6, and closes when current is removed. Typically, the rod can be made to contract around 45 microns due to magnetostriction and from this contraction, open the port. By controlling the current applied to the magnetic coil 6, the nozzle can be controlled to achieve micro-dispensing. The nozzle bottom and top pieces can be made from stainless steel or peek polymer, and the capillary can be an off-the-shelf Peek precision polymer tube of around 0.25 mm in diameter.

Many other embodiments of magnetostrictive nozzles can be realized using the same principle. The nozzle body for example could be made of a different material, or the tip and nozzle housing could be a one-piece component. Optionally, ultrasonic cleaning of the nozzle can also be performed to remove any left-behind residue. The rods can be vibrated at ultrasonic frequencies to effectively clean the nozzle.

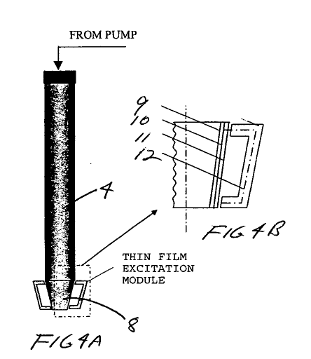

FIG. 3 shows another embodiment of a magnetostrictive nozzle—this one made using a particle actuator. A particle actuator is generally a polymeric composite material with embedded magnetostrictive particles so that application of a magnetic field causes the particle to change in diameter. The particle 7 is shown in FIG. 3 in the top opening of a nozzle 4. The particle, by changing diameter, can plug or unplug the nozzle 4 from a fluid well 3 in a housing 4.

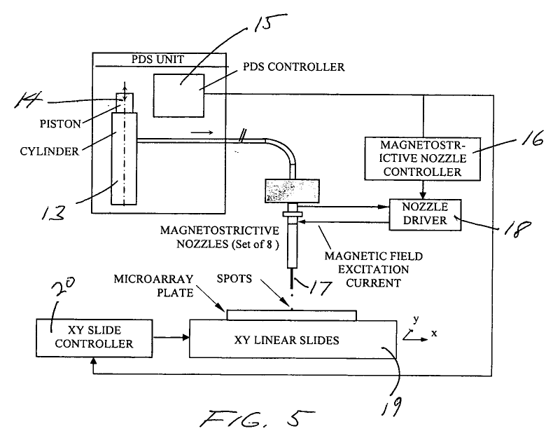

FIGS. 4A and 4B show a magnetostrictive thin film-based nozzle. In embodiment, a nozzle tip 8 can be made of three components: an inner polymeric nozzle tip 9; a magnetostrictive thin film 10, and an outer nonferrous metallic housing 11. When the tip 8 is placed in a magnetic excitation module 12, the thin film changes its dimension in relation to the applied magnetic field. Because the film is fixed at both ends, it can only deflect squeezing the inner tube and producing pressure that can be used to squeeze out a “spot” of fluid.

FIG. 5 shows a total system of the present invention for dispensing fluid “spots”. A precision pump 13 with a piston 14 applies fluid to a magnetostrictive nozzle of one of the embodiments previously described. A controller 15 which usually is a microcontroller controls a magnetostrictive controller 16 which controls opening or closing of the nozzle 17 by applying a magnetic field via a nozzle current driver 18. The entire assembly can be X-Y positioned on a slide by placing the slide on a linear positioner 19 that can be controlled by an X-Y position controller 20.

To use the nozzle for micro-array dispensing, the controller 15 must send signals to the X-Y position controller 20 to step through an array of spot positions. A typical micro-array uses spotting of nano-liter quantities to create “spots” of around 100-150 microns in diameter spaced around 200-250 microns apart. For each spot, the controller 15 must cause the X-Y linear positioner 19 to stop at so the nozzle is over the proper spot position. The pump 13 holds an accurate head pressure throughout the process. The controller 15 can command the magnetostrictive nozzle controller 16 to open the nozzle 17 for exactly the correct length of time to produce the desired spot.

The system of the present invention is not limited to simply one nozzle, but rather can multiplex several nozzles (at least up to 8). The present invention using a magnetostrictive nozzle in combination with a precision pump can achieve dispensing of fluid amounts as low as 50 pico-liters with speeds up to 10 kHz (the speed of dispensing an array on a slide depends on how fast the X-Y positioner can accurately move the slide). As previously stated, when the magnetostrictive nozzle is operated at ultrasonic frequencies, it can act as an ultra-sound source to achieve ultrasonic cleaning of the nozzle.

Various descriptions and illustrations have been used to characterize the present invention. It will be recognized that many changes and variations are possible. These changes and variations are within the scope of the present invention. The scope of the present invention is not limited to the embodiments or figures presented herein.

I claim:

1. A micro-dispensing nozzle comprising:
a housing with at least one exit orifice;
a magnetostrictive valve in proximity to said orifice, said magnetostrictive valve having an open state and a closed state;
a means for applying a magnetic field to said magnetostrictive valve, said magnetostrictive valve changing shape in response to said magnetic field, said changing shape causing said orifice to change states.

2. The magnetostrictive dispensing nozzle of claim 1 wherein said magnetostrictive valve contains a magnetostrictive rod.

3. The magnetostrictive dispensing nozzle of claim 2 wherein said magnetostrictive rod lengthens under application of a magnetic field.

4. The magnetostrictive dispensing nozzle of claim 3 wherein said magnetostrictive rod is held in a pre-extended state by a bias magnetic field.

5. The magnetostrictive dispensing nozzle of claim 4 wherein said pre-extended state of said magnetostrictive rod is relaxed upon application of a control magnetic field, whereby said rod contracts upon application of said control magnetic field causing said orifice to open.

6. The magnetostrictive dispensing nozzle of claim 1 wherein said magnetostrictive valve contains a magnetostrictive particle.

7. The magnetostrictive dispensing nozzle of claim 1 wherein said magnetostrictive valve contains a magnetostrictive layer.

8. The magnetostrictive dispensing nozzle of claim 1 wherein said housing contains an entrance orifice, said entrance orifice coupled to a precision pump.

9. The magnetostrictive dispensing nozzle of claim 1 wherein said means for means for applying a magnetic field is a magnetic field coil exterior to said housing.

10. A magnetostrictive valve to control pico-liter flow from a fluid containing housing said valve comprising a magnetostrictive rod extending into an exit orifice of said housing, said valve being extended to close said exit orifice by a bias magnetic field, said rod responding to an applied control magnetic field to contract allowing said exit orifice to open.

11. The magnetostrictive valve of claim 10 wherein said rod is around 2 mm in diameter.

12. The magnetostrictive valve of claim 10 wherein said rod is around 30 mm in length.

13. The magnetostrictive valve of claim 10 wherein said bias magnetic field is supplied by a permanent magnetic.

14. The magnetostrictive valve of claim 10 wherein said magnetostrictive rod is operated faster than 1 kHz.

15. A magnetostrictive valve method comprising the steps of:
placing a piece of magnetostrictive material in proximity to an exit orifice of a fluid containing housing;
maintaining pressure on fluid in said fluid containing housing;
applying a magnetic field to said magnetostrictive material to cause said magnetostrictive material to change shape, whereby said exit orifice is blocked or un-blocked according to said magnetic field.

16. The magnetostrictive valve method of claim 15 wherein said magnetostrictive material is a magnetostrictive rod.

17. The magnetostrictive valve method of claim 16 further comprising the step of pre-extending said magnetostrictive rod with a bias magnetic field.

18. The magnetostrictive valve method of claim 17 wherein said bias magnetic field is supplied from a permanent magnet.

19. The magnetostrictive valve method of claim 15 wherein said pressure is maintained by a precision pump.

20. The magnetostrictive valve method of claim 19 wherein controlling of said pump and controlling of applying said magnetic field is by a processor.
